(19) United States
(12) Patent Application Publication
(10) Pub. No.: US 2025/0317164 A1
(43) Pub. Date: Oct. 9, 2025

(54) RECONFIGURABLE INTELLIGENT SURFACE CONFIGURATION FOR ORBITAL ANGULAR MOMENTUM

(71) Applicant: Lenovo (Singapore) Pte. Limited, Singapore (SG)

(72) Inventors: Ali Ramadan Ali, Kraiburg (DE); Sher Ali Cheema, Ilmenau (DE); Seyedomid Taghizadeh Motlagh, Oberursel (DE); Soumya Somasekharan Nambiar, Aachen (DE)

(73) Assignee: Lenovo (Singapore) Pte. Limited, Singapore (SG)

(21) Appl. No.: 18/865,023

(22) PCT Filed: May 9, 2023
(86) PCT No.: PCT/IB2023/054798

§ 371 Date: Nov. 12, 2024

Related U.S. Application Data
(60) Provisional application No. 63/341,585, filed on May 13, 2022.

(51) Int. Cl. H04B 7/04; H04B 7/165

(52) U.S. Cl. CPC H04B 7/04013; H04B 7/165

(57) ABSTRACT

Various aspects of the present disclosure relate to network device (e.g., a base station) that transmits a first signaling indicating a first configuration to a reconfigurable intelligent surface (RIS) for an orbital angular momentum (OAM) mode for a reflected signal transmission from the RIS. The network device can also transmit a second signaling to a user equipment (UE) indicating a mapping of a transmission configuration indicator (TCI) to the OAM mode. Additionally, the network device can transmit a third signaling indicating a second configuration to the RIS for multiple OAM modes, and transmit the second signaling to the UE indicating the mapping of the TCI to the multiple OAM modes.

### RELATED APPLICATION

This application claims priority to U.S. Provisional Application Ser. No. 63/341,585 filed May 13, 2022 entitled “Reconfigurable Intelligent Surface Configuration for Orbital Angular Momentum,” the disclosure of which is incorporated by reference herein in its entirety.

### TECHNICAL FIELD

The present disclosure relates to wireless communications, and more specifically to reconfigurable intelligent surface (RIS) configuration.

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In wireless communications, different resource domains are available for transmitting and receiving wireless signals. For instance, resources in the time domain and frequency domain can be utilized by UEs and network devices for wireless transmission and reception. The network devices in a wireless communications system may include the UEs, as well as one or more base stations and RISs that provides for coverage extension of the transmitted and/or received wireless signals.

### SUMMARY

The present disclosure relates to methods, apparatuses, and systems that support RIS configuration for orbital angular momentum (OAM), such as for a configuration of an OAM-capable RIS. Aspects of the configuring techniques described and include configuring a RIS to change and/or generate an OAM mode for uplink (UL) and/or downlink (DL), such as for separating a RIS channel from a direct channel for RIS channel estimation, and for OAM multiplexing of multiple direct and reflected data streams. The configuring techniques also include configuring a RIS to generate multiple modes from a single transmitted mode for diversity gain, and mapping transmission configuration indicator (TCI) states and/or quasi-collocation (QCL) assumptions with OAM modes, as well as configuring a UE to report reference signal received power (RSRP) of modes generated or changed by multiple RISs for RIS selection.

Some implementations of the method and apparatuses described herein may include wireless communication at a device (e.g., a base station, gNB, network device), and the device transmits a first signaling indicating a first configuration to a RIS for an OAM mode for a reflected signal transmission from the RIS. The device also transmits a second signaling to a UE indicating a mapping of a TCI to the OAM mode. The device may also transmit a third signaling indicating a second configuration to the RIS for multiple OAM modes, and transmit the second signaling to the UE indicating the mapping of the TCI to the multiple OAM modes.

In some implementations of the method and apparatuses described herein, the second configuration includes a list of OAM mode numbers associated with the multiple OAM modes, where the OAM mode numbers are based in part on the first signaling indicating the OAM mode. The second configuration includes a list of OAM mode numbers associated with the multiple OAM modes to be generated by the RIS, and configuration information to map one or more OAM modes of the multiple OAM modes to one of multiple spatial directions configured for data transmissions with multiple UEs utilizing different OAM modes of the multiple OAM modes. The second signaling configures the UE to receive multiple data transmissions with the multiple OAM modes using different TCI states associated with respective different RISs. The second signaling configures the UE to transmit multiple data transmissions with the multiple OAM modes using different TCI states associated with respective different RISs. The first configuration includes one or more of a phase, an amplitude, or an element state of one or more RIS elements to configure the RIS for the OAM mode of the reflected signal transmission. The first configuration includes a mode number of the OAM mode for a signal transmission from the device and a mode number of the OAM mode of the reflected signal transmission by the RIS. The first configuration includes one or more of a phase, an amplitude, or an element state of one or more RIS elements to alter the OAM mode of the reflected signal transmission. The second signaling configures the UE with one or more OAM modes for at least one of receiving or transmitting data transmissions, and the one or more OAM modes are mapped to a TCI state and each TCI state is associated with the RIS. The second signaling configures the UE to report one or more RSRP reports that each correspond to an OAM mode associated with the RIS. The device receives, from the UE, one or more RSRP reports that each correspond to an OAM mode associated with the RIS.

Some implementations of the method and apparatuses described herein may include wireless communication at a device (e.g., a RIS), and the device receives, from a base station, a first signaling indicating a first configuration of the RIS for an OAM mode. The device also transmits, to a UE, a reflected signal transmission according to the OAM mode. The device can also receive a second signaling indicating a second configuration for multiple OAM modes.

In some implementations of the method and apparatuses described herein, the second configuration includes a list of OAM mode numbers associated with the multiple OAM modes to be generated by the RIS, where the OAM mode numbers generated by the RIS are based in part on the first signaling indicating the OAM mode. The second configuration includes a list of OAM mode numbers associated with the multiple OAM modes to be generated by the RIS, and includes configuration information to map one or more OAM modes of the multiple OAM modes to one of multiple spatial directions configured for data transmissions with multiple UEs utilizing different OAM modes of the multiple OAM modes. The first configuration includes one or more of a phase, an amplitude, or an element state of one or more RIS elements to configure the apparatus for the OAM mode of the reflected signal transmission. The first configuration includes a mode number of the OAM mode for a signal transmission from the base station and a mode number of the OAM mode of the reflected signal transmission by the RIS. The first configuration includes one or more of a phase, an amplitude, or an element state of one or more RIS elements to alter the OAM mode of the reflected signal transmission.

Some implementations of the method and apparatuses described herein may include wireless communication at a device (e.g., a UE), and the device receives a signaling from a base station indicating a mapping of a TCI to an OAM mode for a reflected signal transmission from a RIS. The device also receives the reflected signal transmission from the RIS according to the indicated OAM mode.

In some implementations of the method and apparatuses described herein, the signaling from the base station indicates the mapping of the TCI to multiple OAM modes associated with a configuration of the RIS for the multiple OAM modes. The signaling configures the apparatus to receive multiple data transmissions with the multiple OAM modes using different TCI states associated with respective different RISs. The signaling configures the apparatus to transmit multiple data transmissions with the multiple OAM modes using different TCI states associated with respective different RISs. The signaling configures the apparatus with one or more OAM modes for at least one of receiving or transmitting data transmissions, and the one or more OAM modes are mapped to a TCI state and each TCI state is associated with the RIS. The signaling configures the apparatus to report one or more RSRP reports that each correspond to an OAM mode associated with the RIS. The UE transmits one or more RSRP reports that each correspond to an OAM mode associated with the RIS.

### BRIEF DESCRIPTION OF THE DRAWINGS

Various aspects of the present disclosure for RIS configuration for OAM are described with reference to the following Figures. The same numbers may be used throughout to reference like features and components shown in the Figures.

FIG. 1 illustrates an example of a wireless communications system that supports RIS configuration for OAM in accordance with aspects of the present disclosure.

FIG. 2 illustrates an example of OAM modes of an OAM wave, as related to RIS configuration for OAM in accordance with aspects of the present disclosure.

FIG. 3 illustrates an example of antenna phases and generation of OAM modes, as related to RIS configuration for OAM in accordance with aspects of the present disclosure.

FIG. 4 illustrates an example of multiple OAM mode generation implemented with multiple uniform circular arrays, as related to RIS configuration for OAM in accordance with aspects of the present disclosure.

FIG. 5 illustrates an example of configuring a RIS to change an OAM mode for RIS channel estimation, as related to RIS configuration for OAM in accordance with aspects of the present disclosure.

FIG. 6 illustrates an example of configuring a RIS and a UE with multiple TCI states and multiple OAM modes, as related to RIS configuration for OAM in accordance with aspects of the present disclosure.

FIG. 7 illustrates an example of configuring a RIS to generate multiple OAM modes, as related to RIS configuration for OAM in accordance with aspects of the present disclosure.

FIG. 8 illustrates an example of configuring a RIS and a UE for OAM to TCI state mapping, as related to RIS configuration for OAM in accordance with aspects of the present disclosure.

FIG. 9 illustrates an example block diagram of components of a device (e.g., a UE, or a RIS) that supports RIS configuration for OAM in accordance with aspects of the present disclosure.

FIG. 10 illustrates an example block diagram of components of a device (e.g., a base station) that supports RIS configuration for OAM in accordance with aspects of the present disclosure.

FIGS. 11-14 illustrate flowcharts of methods that support RIS configuration for OAM in accordance with aspects of the present disclosure.

### DETAILED DESCRIPTION

Implementations of RIS configuration for OAM are described, such as related to configuring a RIS to change and/or generate an OAM mode for UL and/or DL, such as for separating a RIS channel from a direct channel for RIS channel estimation, and for OAM multiplexing of multiple direct and reflected data streams. The configuring techniques also include configuring a RIS to generate multiple modes from a single transmitted mode for diversity gain, and mapping TCI states and/or QCL assumptions with OAM modes, as well as configuring a UE to report RSRP of modes generated or changed by multiple RISs for RIS selection.

The implementation of a RIS in a wireless communications network provides for coverage extension of downlink and/or uplink transmissions, and is particularly useful to alleviate signal blockage that causes a drop of signal-to-noise ratio (SNR) or beam failure of the DL/UL beams. A RIS can be configured with control information received from a network device (e.g., a base station, gNB) for efficient reflection of a transmission signal that makes use of time and spatial information of the Uu link provided by the network. This control information may include time as well as common and UE dedicated spatial information for beamforming. The ability to control the RIS to perform a specific beamforming of a reflected signal towards a preferred direction with configurable beam gain and width has many communication applications.

Additionally, OAM may be implemented and utilized in wireless communication due to the potential gain that it provides in terms of enhancing system capacity by utilizing spatial distribution of helical phase front to serve multiple UEs or a UE with multiple data streams using the same time, frequency, space, power, and code resources. Additionally, the spiral phase plate (SPP) or the uniform circular array (UCA) used to generate OAM modes can be implemented at a location other than at the transmitter. In this regard a RIS can be manufactured with meta material that is used as an SPP or UCA to manipulate or generate one or more OAM modes. In implementations, the network device (e.g., base station) can provide the control information to the RIS controller to apply the designated OAM mode on the RIS. In aspects of this disclosure, techniques are presented for the control configuration from the network device to a RIS and/or to a UE to perform RIS based OAM modes for transmission and reception.

Aspects of the present disclosure are described in the context of a wireless communications system. Aspects of the present disclosure are further illustrated and described with reference to device diagrams and flowcharts that relate to RIS configuration for OAM.

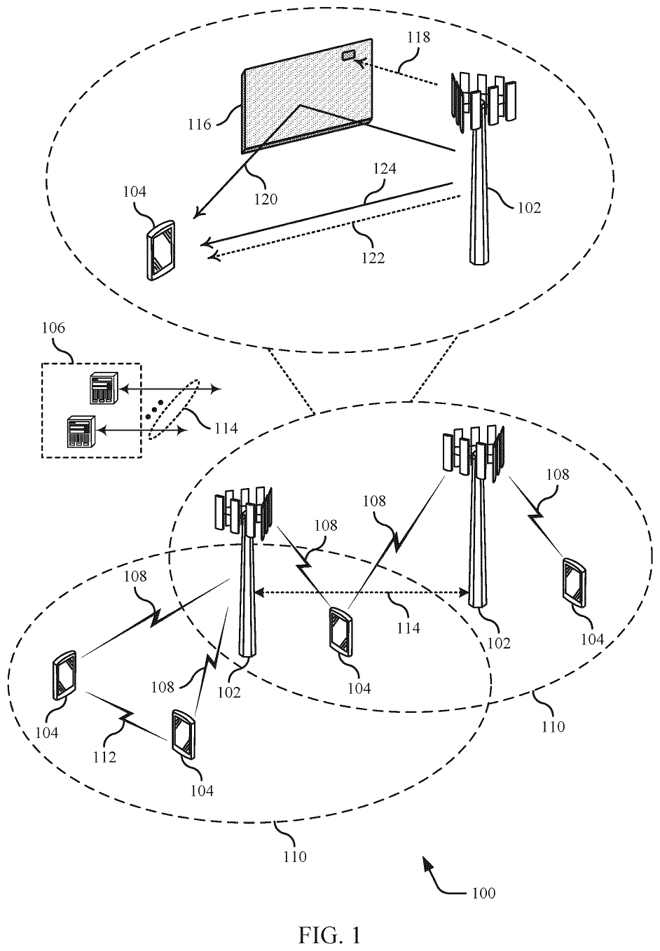

FIG. 1 illustrates an example of a wireless communications system 100 that supports RIS configuration for OAM in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104, base stations 102, and RISs 116 are operable to implement various aspects of RIS configuration for OAM, as described herein. For instance, a base station 102 can communicate a signaling 118 indicating a configuration to a RIS controller of a RIS 116 for an OAM mode for a reflected signal transmission 120 from the RIS 116 to the UE 104. In an implementation, the signaling 118 may indicate a configuration to the RIS 116 for multiple OAM modes. The base station 102 can also communicate another signaling 122 to the UE 104 indicating a mapping of a TCI to the OAM mode and/or the mapping of the TCI to the multiple OAM modes. Accordingly, the reflected signal transmission 120 from the RIS 116 is of a different OAM mode than that of the incident signal 124 communicated from the base station 102 to the UE 104.

In aspects of RIS configuration for OAM, reconfigurable intelligent surfaces, also known as intelligent reflecting surfaces (IRSs) or large intelligent surfaces (LISs), provide a potential to enhance the capacity and coverage of wireless networks by intelligently reconfiguring the propagation environment by adjusting the phase and the amplitude of the RIS elements. In aspects of the disclosure, configuring and utilizing RISs for the sixth generation (6G) wireless communication networks is cost effective, given that RIS technology does not require digital-to-analog (DAC)/DAC converters nor power amplifiers, and meets the green communications requirements. A RIS is constructed of a large number of low-cost and passive elements that can modify radio waves impinging upon them, and can be easily coated on the existing infrastructures. The RISs also potentially have a large impact on the design of future wireless systems, particularly when integrated with other emerging and advanced technologies, such as Terahertz communication, massive multiple input multiple output (MIMO), AI/ML based systems, and the like, and can be used for different applications such as communication, sensing, positioning, etc. To control the phases and amplitude of the RIS elements, interface to the network is needed to adapt the reflection characteristics of the RIS based on the channel conditions and the transmission needs.

With reference to antenna ports quasi co-location, a UE can be configured with a list of up to M TCI-state configurations within the higher layer parameter physical downlink shared channel (PDSCH)-config to decode PDSCH according to a detected physical downlink control channel (PDCCH) with downlink control information (DCI) intended for the UE and the given serving cell, where M depends on the UE capability maxNumberConfiguredTCIstatesPerCC. Each TCI-state contains parameters for configuring a quasi co-location relationship between one or two downlink reference signals and the demodulation reference signal (DM-RS) ports of the PDSCH, the DM-RS port of PDCCH, or the channel state information (CSI)-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values: ‘typeA’: {Doppler shift, Doppler spread, average delay, delay spread}; ‘typeB’: {Doppler shift, Doppler spread}; ‘typeC’: {Doppler shift, average delay}; or ‘typeD’: {Spatial Rx parameter}.

The UE receives an activation command used to map up to eight (8) TCI states to the codepoints of the DCI field ‘Transmission Configuration Indication’ in one control channel (CC)/DL bandwidth part (BWP) or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs. When a UE supports two TCI states in a codepoint of the DCI field ‘Transmission Configuration Indication’, the UE may receive an activation command that is used to map up to eight (8) combinations of one or two TCI states to the codepoints of the DCI field ‘Transmission Configuration Indication’. The UE is not expected to receive more than eight (8) TCI states in the activation command. When the DCI field ‘Transmission Configuration Indication’ is present in DCI format 1_2, and when the number of codepoints S in the DCI field ‘Transmission Configuration Indication’ of DCI format 1_2 is smaller than the number of TCI codepoints that are activated by the activation command, only the first S activated codepoints are applied for DCI format 1_2.

When the UE transmits a physical uplink control channel (PUCCH) with hybrid automatic repeat request-acknowledgement (HARQ-ACK) information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ}$$

where m is the subcarrier spacing (SCS) configuration for the PUCCH. If tci-PresentInDCI is set to ‘enabled’ or tci-PresentDCI-1-2 is configured for the control resource set (CORESET) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal (SS)/physical broadcast channel (PBCH) block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-state according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability. When the UE is configured with a single slot PDSCH, the indicated TCI state should be based on the activated TCI states in the slot with the scheduled PDSCH.

When the UE is configured with a multi-slot PDSCH, the indicated TCI state should be based on the activated TCI states in the first slot with the scheduled PDSCH, and the UE shall expect the activated TCI states are the same across the slots with the scheduled PDSCH. When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentDCI-1-2 in radio resource control (RRC) connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, then the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band carrier aggregation (CA) case (when PDSCH and the CORESET are in different component carriers).

If a UE is configured with enableDefaultTCIStatePerCoresetPoolIndex and the UE is configured by higher layer parameter PDCCH-Config that contains two different values of coresetPoolIndex in different ControlResourceSets, the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).

If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

Conventional wireless communication designs are built on the plane-electromagnetic wave. However, the electromagnetic (EM) wave possesses not only linear momentum, but also angular momentum, which contains either the spin angular momentum (SAM) or OAM. OAM is a wavefront with helical phase OAM and has a great number of topological charges, that are referred as OAM-modes. Beams with different OAM-modes are orthogonal to each other and they can be multiplexed and demultiplexed together, thus increasing the capacity without relying on the traditional resources such as time and frequency. OAM is formed by microscopic particles moving in a circle along the propagation direction, which is related to the spatial distribution of particles. It is macroscopically represented as a vortex beam carrying the wavefront phase factor exp(jl ϕ) (where “l” is the topological charge of the wave or azimuthal order or index, or even the roll index and determines the number of OAM modes, and “ϕ” represents emission phase angle or roll angle).

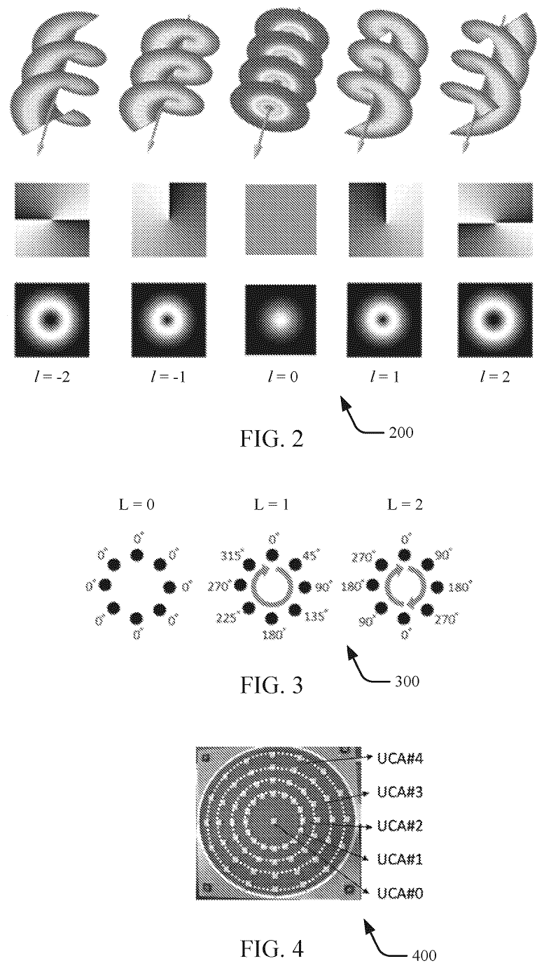

FIG. 2 illustrates an example 200 of OAM modes of an OAM wave, as related to RIS configuration for OAM. FIG. 3 illustrates an example 230 of antenna phases and generation of OAM modes, as related to RIS configuration for OAM. (FIG. 3 Ref: Appl. Sci. 2019, 9, 1729; doi:10.3390/app9091729, licensed under Creative Commons BY 4.0). To generate the beam carrying an OAM mode n(L=n), antenna elements are connected with phase shifters that make n×360 degrees of rotation. The example 300 shows beam generations of OAM modes 0, 1, and 2 using uniform circular arrays (UCAs) consisting of eight (8) antenna elements.

FIG. 4 illustrates an example 400 of multiple OAM mode generation implemented with multiple uniform circular arrays, as related to RIS configuration for OAM. (FIG. 4 Ref: Appl. Sci. 2019, 9, 1729; doi:10.3390/app9091729, licensed under Creative Commons BY 4.0). Notably, it is possible to use either a single UCA or multiple UCAs for multiple OAM mode generation, as shown in the example 400. In the former case, superposed beams are transmitted by a single UCA. In the latter case, concentric multiple UCAs can be used. The separation of beams carrying OAM modes can be performed similar to generation using antenna elements connected with phase shifters that make opposite rotation directions. As long as the number of antenna elements is larger than 2n, rotations of n×360 degrees are orthogonal to one another. Therefore, each OAM mode can be separated from mixed OAM modes' signals without aliasing. Such beam separation can also be performed by using a single UCA or multiple UCAs as in the beam generation. Note that a divider is equipped between antenna elements and phase shifters in the former case. To avoid confusion regarding the term “multiple UCAs”, this disclosure refers to superposition-based beam generation using a single UCA, as described. As illustrated in the example 400, the multiple antenna arrays can generate simultaneous, same OAM modes.

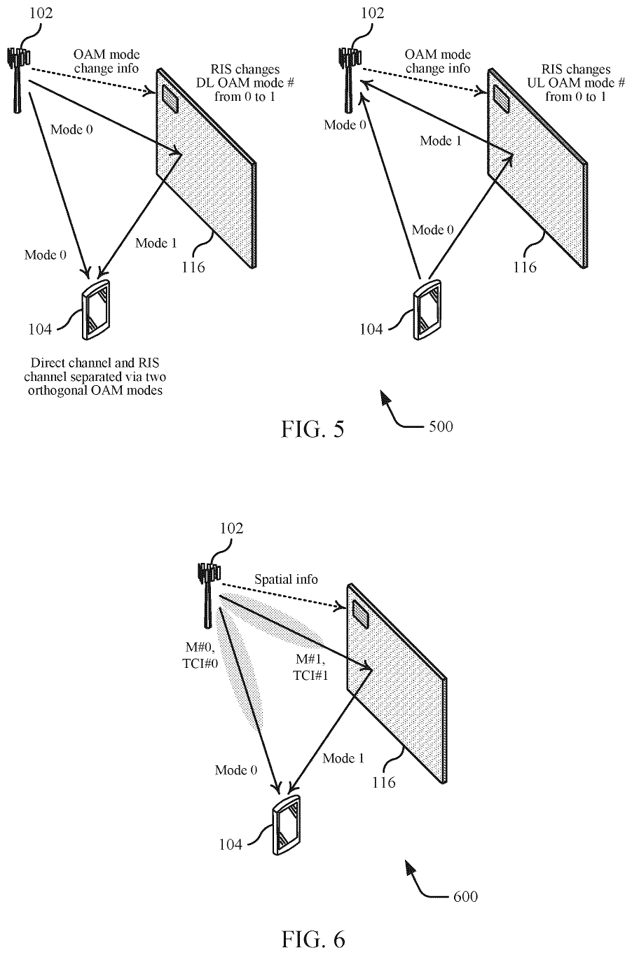

FIG. 5 illustrates an example 500 of configuring a RIS to change an OAM mode for RIS channel estimation (both DL and UL), as related to RIS configuration for OAM. Aspects of the disclosure take into account RIS mode rotation configuration for RIS channel estimation. In an implementation, a network node (e.g., a base station 102 with a local RIS control function) can transmit a first configuration message to a connected RIS 116 for OAM mode change or correction, and/or for OAM mode generation. The network node can transmit a second configuration to a RIS controller of the RIS 116 for generating multiple OAM modes with multiple spatial directions to serve multiple UEs. The base station 102 can communicate configuration signaling with the RIS controller inband with a transmitted signal, or via an out of band transmission between the base station and the RIS controller.

The network node can also transmit a configuration to the UE 104 for mapping between the OAM modes and TCI states associated with one or more RISs. A RIS synchronized and connected to the network node is configured to apply a corresponding configuration to generate the required OAM modes, such that a reflected signal by the RIS towards the UE and/or the base station has different OAM mode(s) than that of the incident signal. Modifying the OAM mode at the RIS can be used to compensate for the mode divergence caused by multipath and/or by the atmospheric disturbance. Based on the UE reports of different received OAM modes, the base station can configure the RIS to adjust the OAM mode so that the inter-mode interference is minimized at the receiver side. Furthermore, the RIS can apply corresponding control configuration such that the reflected signal has an orthogonal OAM mode with the incident signal. This can be used at the receiver side to separate the direct channel from the RIS channel to enhance the optimization of the RIS, such as shown in the example 500, which illustrates both downlink from the base station to the UE via the RIS, and uplink from the UE to the base station via the RIS.

As shown in the example 500 for the DL case, the base station configures the RIS to generate an OAM mode orthogonal to the mode used to transmit (e.g., a reference signal from the base station). In an implementation, the base station transmits to the RIS explicit phase, amplitude, and element state information for each element, or for groups of elements, to be applied by the RIS controller so that the signal is reflected with the required OAM mode. In another implementation, the configuration contains information about the OAM mode number of the transmitted signal and the required OAM mode number for the reflected signal. The RIS applies the corresponding parameters to its elements to modify the mode. The base station configures the UE to receive two OAM modes using its UCA antennas, where one is directly coming from the base station and the other one is generated and reflected by the RIS. The transmitted signal from the base station may contain a reference signal transmitted with a single OAM mode. The UE can measure the reference signal using two different OAM modes for reception, and report the RSRP and/or CSI for each mode to the base station. The first report represents the CSI of the direct channel, while the second report represents the CSI of the RIS channel so that separated channel information can be used to optimize the reflection of the RIS.

FIG. 6 illustrates an example 600 of configuring a RIS and a UE with multiple TCI states and multiple OAM modes, as related to RIS configuration for OAM. In an implementation, the base station 102 transmits a configuration to the RIS 116 for receiving a specific OAM mode from the base station and/or a UE 104, and configures the UE to receive two OAM modes with multiple data streams (e.g., first data stream is beamformed with OAM mode #0 towards the RIS, and the second data stream is beamformed towards the UE with OAM mode #1, so that extra separation gain can be achieved for multi stream on multi OAM mode transmission, as shown in the example 600.

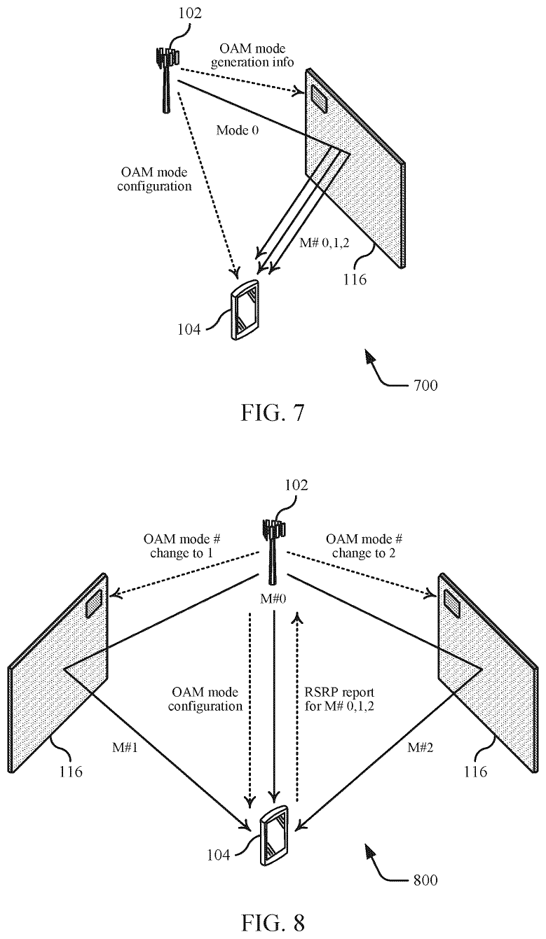

FIG. 7 illustrates an example 700 of configuring a RIS to generate multiple OAM modes, as related to RIS configuration for OAM. Aspects of the disclosure take into account RIS configuration for multi-mode OAM generation. In an implementation, a network node (e.g., a base station 102 with a local RIS control function) can transmit a configuration message to the RIS 116, where the configuration contains information for generating multiple OAM modes from a single or multiple transmitted OAM modes. A RIS synchronized and connected to the network node is configured to apply a corresponding configuration to generate multiple OAM modes, such that a reflected signal by the RIS towards the UE(s) 104 has more OAM mode(s) than that of the incident signal. In an implementation, the base station configures the RIS to receive a single OAM mode and reflect the signal with multiple OAM modes towards the UE. Generating multiple OAM modes via the RIS can be used to gain mode diversity at the UE and/or at base station, and thus enhance the reception performance, as shown in the example 700.

As different OAM modes exhibit different propagation characteristics through the multipath channel, a UE can combine the signal received by multiple OAM modes to enhance the signal quality. In another implementation, the base station configures the RIS to receive multiple OAM modes from the base station and to apply spatial information mapped to the received OAM mode. The RIS applies the required spatial information to reflect each received OAM mode to a particular direction, so that if the transmitted OAM modes from the base station are meant for multiple UEs, then the spatial information of the OAM mode for each UE based on the UE location and/or CSI report facilitates the space separation of the OAM modes to minimize the inter-mode interference for the OAM mode divergence caused by multipath and/or by the atmospheric disturbance. In an implementation, the base station may explicitly configure the RIS with required parameters for each element, or for each group of elements, to generate the required OAM modes towards the required spatial direction. In another implementation, the base station configures the RIS with a list of OAM modes to be generated and indices to map the OAM mode to a specific TCI state and/or spatial direction.

Based on the UE reports of different received OAM modes, the base station can configure the RIS to adjust the OAM mode so that the inter-mode interference is minimized at the receiver side. Furthermore, the RIS can apply a corresponding control configuration such that the reflected signal has an orthogonal OAM mode with the incident signal. This can be used at the receiver side to separate the direct channel from the RIS channel.

FIG. 8 illustrates an example 800 of configuring a RIS and a UE for OAM to TCI state mapping, as related to RIS configuration for OAM. Aspects of the disclosure take into account configuration for associating multiple OAM modes with multiple RISs for RIS selection. In an implementation, a network node (e.g., a base station 102 with a local RIS control function) can transmit a configuration message to a connected UE 104, where in the configuration contains information for receiving multiple OAM modes reflected from multiple RISs. The multiple RISs are synchronized and connected to the network node, and are configured to apply a corresponding configuration to change or generate an OAM mode, such that the reflected signal by one RIS towards the UE(s) has a different OAM mode than that of the incident signal and that of the reflected signals from the other RISs, as shown in the example 800.

The base station sends, to the UE, OAM mode numbers to be observed and measured by the UE, where each OAM mode is reflected via one RIS in the network. In an implementation, the configuration further includes information for mapping the TCI states used for transmitting the signal from the base station and the reflected signal via the RISs with the corresponding OAM modes, and the UE uses different spatial filters to receive different OAM modes reflected from different RISs. In another implementation, the configuration includes information for the UE to receive all OAM modes with a single TCI state or QCL assumption. The UE is further configured with resources to report multiple RSRP to the base station, where each report is associated with an OAM mode that corresponds to a RIS. Upon receiving the reports from the UE, the base station selects the RIS that corresponds to the best RSRP measured by the UE for the different OAM modes to serve the reporting UE. A benefit of the described configuration is that the base station doesn't need to send each RIS different CSI-RS for identifying the quality of the reflected signal from the different RISs. As the mode is applied at the RIS side, a single CSI-RS port can be used from the base station, and the identification of different RISs is based on the different OAM modes generated from the different RISs.

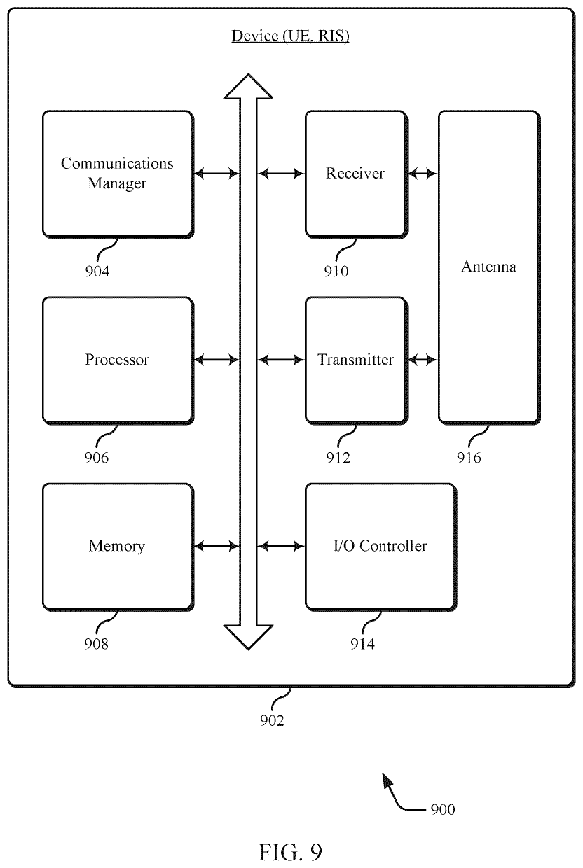

FIG. 9 illustrates an example of a block diagram 900 of a device 902 that supports RIS configuration for OAM in accordance with aspects of the present disclosure. The device 902 may be an example of a UE 104 or a RIS 116 as described herein. The device 902 may support wireless communication and/or network signaling with one or more base stations 102, other UEs 104, RISs 116, network entities and devices, or any combination thereof. The device 902 may include components for bi-directional communications including components for transmitting and receiving communications, such as a communications manager 904, a processor 906, a memory 908, a receiver 910, a transmitter 912, and an I/O controller 914. These components may be in electronic communication or otherwise coupled (e.g., operatively, communicatively, functionally, electronically, electrically) via one or more interfaces (e.g., buses).

The communications manager 904, the receiver 910, the transmitter 912, or various combinations thereof or various components thereof may be examples of means for performing various aspects of the present disclosure as described herein. For example, the communications manager 904, the receiver 910, the transmitter 912, or various combinations or components thereof may support a method for performing one or more of the functions described herein.

In some implementations, the communications manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally or alternatively, in some implementations, the communications manager 904, the receiver 910, the transmitter 912, or various combinations or components thereof may be implemented in code (e.g., as communications management software or firmware) executed by the processor 906. If implemented in code executed by the processor 906, the functions of the communications manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 904 may be configured to perform various operations (e.g., receiving, monitoring, transmitting) using or otherwise in cooperation with the receiver 910, the transmitter 912, or both. For example, the communications manager 904 may receive information from the receiver 910, send information to the transmitter 912, or be integrated in combination with the receiver 910, the transmitter 912, or both to receive information, transmit information, or perform various other operations as described herein. Although the communications manager 904 is illustrated as a separate component, in some implementations, one or more functions described with reference to the communications manager 904 may be supported by or performed by the processor 906, the memory 908, or any combination thereof. For example, the memory 908 may store code, which may include instructions executable by the processor 906 to cause the device 902 to perform various aspects of the present disclosure as described herein, or the processor 906 and the memory 908 may be otherwise configured to perform or support such operations.

For example, the communications manager 904 may support wireless communication and/or network signaling at a device (e.g., the device 902, a UE) in accordance with examples as disclosed herein. The communications manager 904 and/or other device components may be configured as or otherwise support an apparatus, such as a UE, including a transceiver; a processor coupled to the transceiver, the processor and the transceiver configured to cause the apparatus to: receive a signaling from a base station indicating a mapping of a TCI to an OAM mode for a reflected signal transmission from a RIS; and receive the reflected signal transmission from the RIS according to the OAM mode.

Additionally, the apparatus (e.g., a UE) includes any one or combination of: the signaling from the base station indicates the mapping of the TCI to multiple OAM modes associated with a configuration of the RIS for the multiple OAM modes. The signaling configures the apparatus to receive multiple data transmissions with the multiple OAM modes using different TCI states associated with respective different RISs. The signaling configures the apparatus to transmit multiple data transmissions with the multiple OAM modes using different TCI states associated with respective different RISs. The signaling configures the apparatus with one or more OAM modes for at least one of receiving or transmitting data transmissions, and the one or more OAM modes are mapped to a TCI state and each TCI state is associated with the RIS. The signaling configures the apparatus to report one or more RSRP reports that each correspond to an OAM mode associated with the RIS. The processor and the transceiver are configured to cause the apparatus to transmit one or more RSRP reports that each correspond to an OAM mode associated with the RIS.

The communications manager 904 and/or other device components may be configured as or otherwise support a means for wireless communication and/or network signaling at a UE, including receiving a signaling from a base station indicating a mapping of a TCI to an OAM mode for a reflected signal transmission from a RIS; and receiving the reflected signal transmission from the RIS according to the OAM mode.

Additionally, wireless communication and/or network signaling at the UE includes any one or combination of: the signaling from the base station indicates the mapping of the TCI to multiple OAM modes associated with a configuration of the RIS for the multiple OAM modes. The signaling configures a UE to receive multiple data transmissions with the multiple OAM modes using different TCI states associated with respective different RISs. The signaling configures a UE to transmit multiple data transmissions with the multiple OAM modes using different TCI states associated with respective different RISs. The signaling configures a UE with one or more OAM modes for at least one of receiving or transmitting data transmissions, and the one or more OAM modes are mapped to a TCI state and each TCI state is associated with the RIS. The signaling configures a UE to report one or more RSRP reports that each correspond to an OAM mode associated with the RIS. The method further comprising transmitting one or more RSRP reports that each correspond to an OAM mode associated with the RIS.

In another example, the communications manager 904 may support wireless communication and/or network signaling at a device (e.g., the device 902, a RIS) in accordance with examples as disclosed herein. The communications manager 904 and/or other device components may be configured as or otherwise support an apparatus, such as a RIS, including a transceiver; a processor coupled to the transceiver, the processor and the transceiver configured to cause the apparatus to: receive, from a base station, a first signaling indicating a first configuration of the apparatus for an OAM mode; and transmit, to a UE, a reflected signal transmission according to the OAM mode.

Additionally, the apparatus (e.g., a RIS) includes any one or combination of: the processor and the transceiver are configured to cause the apparatus to receive a second signaling indicating a second configuration for multiple OAM modes. The second configuration comprises a list of OAM mode numbers associated with the multiple OAM modes to be generated by the apparatus, the OAM mode numbers generated by the apparatus based at least in part on the first signaling indicating the OAM mode. The second configuration comprises a list of OAM mode numbers associated with the multiple OAM modes to be generated by the apparatus; and configuration information to map one or more OAM modes of the multiple OAM modes to one of multiple spatial directions configured for data transmissions with multiple UEs utilizing different OAM modes of the multiple OAM modes. The first configuration comprises one or more of a phase, an amplitude, or an element state of one or more RIS elements to configure the apparatus for the OAM mode of the reflected signal transmission. The first configuration comprises a mode number of the OAM mode for a signal transmission from the base station and a mode number of the OAM mode of the reflected signal transmission by the apparatus. The first configuration comprises one or more of a phase, an amplitude, or an element state of one or more RIS elements to alter the OAM mode of the reflected signal transmission.

The communications manager 904 and/or other device components may be configured as or otherwise support a means for wireless communication and/or network signaling at a RIS, including receiving, from a base station, a first signaling indicating a first configuration of a RIS for an OAM mode; and transmit, to a UE, a reflected signal transmission according to the OAM mode.

Additionally, wireless communication and/or network signaling at the RIS includes any one or combination of: receiving a second signaling indicating a second configuration for multiple OAM modes. The second configuration comprises a list of OAM mode numbers associated with the multiple OAM modes to be generated by the RIS, the OAM mode numbers generated by the RIS based at least in part on the first signaling indicating the OAM mode. The second configuration comprises a list of OAM mode numbers associated with the multiple OAM modes to be generated by the RIS; and configuration information to map one or more OAM modes of the multiple OAM modes to one of multiple spatial directions configured for data transmissions with multiple UEs utilizing different OAM modes of the multiple OAM modes. The first configuration comprises one or more of a phase, an amplitude, or an element state of one or more RIS elements to configure the RIS for the OAM mode of the reflected signal transmission. The first configuration comprises a mode number of the OAM mode for a signal transmission from the base station and a mode number of the OAM mode of the reflected signal transmission by the RIS. The first configuration comprises one or more of a phase, an amplitude, or an element state of one or more RIS elements to alter the OAM mode of the reflected signal transmission.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause the device 902 to perform various functions of the present disclosure.

The memory 908 may include random access memory (RAM) and read-only memory (ROM). The memory 908 may store computer-readable, computer-executable code including instructions that, when executed by the processor 906 cause the device 902 to perform various functions described herein. The code may be stored in a non-transitory computer-readable medium such as system memory or another type of memory. In some implementations, the code may not be directly executable by the processor 906 but may cause a computer (e.g., when compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the device 902. The I/O controller 914 may also manage peripherals not integrated into the device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the device 902 via the I/O controller 914 or via hardware components controlled by the I/O controller 914.

In some implementations, the device 902 may include a single antenna 916. However, in some other implementations, the device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

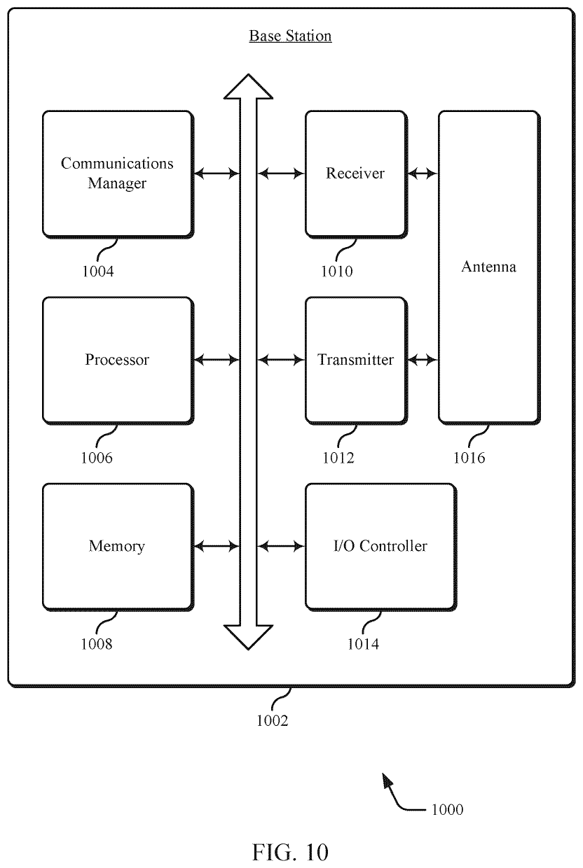

FIG. 10 illustrates an example of a block diagram 1000 of a device 1002 that supports RIS configuration for OAM in accordance with aspects of the present disclosure. The device 1002 may be an example of a base station 102 (e.g., a gNB) as described herein. The device 1002 may support wireless communication and/or network signaling with one or more base stations 102, UEs 104, RISs 116, core network devices and functions (e.g., core network 106), or any combination thereof. The device 1002 may include components for bi-directional communications including components for transmitting and receiving communications, such as a communications manager 1004, a processor 1006, a memory 1008, a receiver 1010, a transmitter 1012, and an I/O controller 1014. These components may be in electronic communication or otherwise coupled (e.g., operatively, communicatively, functionally, electronically, electrically) via one or more interfaces (e.g., buses).

The communications manager 1004, the receiver 1010, the transmitter 1012, or various combinations thereof or various components thereof may be examples of means for performing various aspects of the present disclosure as described herein. For example, the communications manager 1004, the receiver 1010, the transmitter 1012, or various combinations or components thereof may support a method for performing one or more of the functions described herein.

In some implementations, the communications manager 1004, the receiver 1010, the transmitter 1012, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1006 and the memory 1008 coupled with the processor 1006 may be configured to perform one or more of the functions described herein (e.g., by executing, by the processor 1006, instructions stored in the memory 1008).

Additionally or alternatively, in some implementations, the communications manager 1004, the receiver 1010, the transmitter 1012, or various combinations or components thereof may be implemented in code (e.g., as communications management software or firmware) executed by the processor 1006. If implemented in code executed by the processor 1006, the functions of the communications manager 1004, the receiver 1010, the transmitter 1012, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1004 may be configured to perform various operations (e.g., receiving, monitoring, transmitting) using or otherwise in cooperation with the receiver 1010, the transmitter 1012, or both. For example, the communications manager 1004 may receive information from the receiver 1010, send information to the transmitter 1012, or be integrated in combination with the receiver 1010, the transmitter 1012, or both to receive information, transmit information, or perform various other operations as described herein. Although the communications manager 1004 is illustrated as a separate component, in some implementations, one or more functions described with reference to the communications manager 1004 may be supported by or performed by the processor 1006, the memory 1008, or any combination thereof. For example, the memory 1008 may store code, which may include instructions executable by the processor 1006 to cause the device 1002 to perform various aspects of the present disclosure as described herein, or the processor 1006 and the memory 1008 may be otherwise configured to perform or support such operations.

For example, the communications manager 1004 may support wireless communication and/or network signaling at a device (e.g., the device 1002, a base station) in accordance with examples as disclosed herein. The communications manager 1004 and/or other device components may be configured as or otherwise support an apparatus, such as a base station, including a transceiver; a processor coupled to the transceiver, the processor and the transceiver configured to cause the apparatus to: transmit a first signaling indicating a first configuration to a RIS for an OAM mode for a reflected signal transmission from the RIS; and transmit a second signaling to a UE indicating a mapping of a TCI to the OAM mode.

Additionally, the apparatus (e.g., a base station) includes any one or combination of: the processor and the transceiver are configured to cause the apparatus to transmit a third signaling indicating a second configuration to the RIS for multiple OAM modes; and transmit the second signaling to the UE indicating the mapping of the TCI to the multiple OAM modes. The second configuration comprises a list of OAM mode numbers associated with the multiple OAM modes, the OAM mode numbers based at least in part on the first signaling indicating the OAM mode. The second configuration comprises a list of OAM mode numbers associated with the multiple OAM modes to be generated by the RIS; and configuration information to map one or more OAM modes of the multiple OAM modes to one of multiple spatial directions configured for data transmissions with multiple UEs utilizing different OAM modes of the multiple OAM modes. The second signaling configures the UE to receive multiple data transmissions with the multiple OAM modes using different TCI states associated with respective different RISs. The second signaling configures the UE to transmit multiple data transmissions with the multiple OAM modes using different TCI states associated with respective different RISs. The first configuration comprises one or more of a phase, an amplitude, or an element state of one or more RIS elements to configure the RIS for the OAM mode of the reflected signal transmission. The first configuration comprises a mode number of the OAM mode for a signal transmission from the apparatus and a mode number of the OAM mode of the reflected signal transmission by the RIS. The first configuration comprises one or more of a phase, an amplitude, or an element state of one or more RIS elements to alter the OAM mode of the reflected signal transmission. The second signaling configures the UE with one or more OAM modes for at least one of receiving or transmitting data transmissions, and the one or more OAM modes are mapped to a TCI state and each TCI state is associated with the RIS. The second signaling configures the UE to report one or more RSRP reports that each correspond to an OAM mode associated with the RIS. The processor and the transceiver are configured to cause the apparatus to receive, from the UE, one or more RSRP reports that each correspond to an OAM mode associated with the RIS.

The communications manager 1004 and/or other device components may be configured as or otherwise support a means for wireless communication and/or network signaling at a base station, including transmitting a first signaling indicating a first configuration to a RIS for an OAM mode for a reflected signal transmission from the RIS; and transmitting a second signaling to a UE indicating a mapping of a TCI to the OAM mode.

Additionally, wireless communication at the base station includes any one or combination of: transmitting a third signaling indicating a second configuration to the RIS for multiple OAM modes; and transmitting the second signaling to the UE indicating the mapping of the TCI to the multiple OAM modes. The second configuration comprises a list of OAM mode numbers associated with the multiple OAM modes, the OAM mode numbers based at least in part on the first signaling indicating the OAM mode. The second configuration comprises a list of OAM mode numbers associated with the multiple OAM modes to be generated by the RIS; and configuration information to map one or more OAM modes of the multiple OAM modes to one of multiple spatial directions configured for data transmissions with multiple UEs utilizing different OAM modes of the multiple OAM modes. The second signaling configures the UE to receive multiple data transmissions with the multiple OAM modes using different TCI states associated with respective different RISs. The second signaling configures the UE to transmit multiple data transmissions with the multiple OAM modes using different TCI states associated with respective different RISs. The first configuration comprises one or more of a phase, an amplitude, or an element state of one or more RIS elements to configure the RIS for the OAM mode of the reflected signal transmission. The first configuration comprises a mode number of the OAM mode for a signal transmission from the base station and a mode number of the OAM mode of the reflected signal transmission by the RIS. The first configuration comprises one or more of a phase, an amplitude, or an element state of one or more RIS elements to alter the OAM mode of the reflected signal transmission. The second signaling configures the UE with one or more OAM modes for at least one of receiving or transmitting data transmissions, and the one or more OAM modes are mapped to a TCI state and each TCI state is associated with the RIS. The second signaling configures the UE to report one or more RSRP reports that each correspond to an OAM mode associated with the RIS. The method further comprising receiving, from the UE, one or more RSRP reports that each correspond to an OAM mode associated with the RIS.

The processor 1006 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1006 may be configured to operate a memory array using a memory controller. In some other implementations, a memory controller may be integrated into the processor 1006. The processor 1006 may be configured to execute computer-readable instructions stored in a memory (e.g., the memory 1008) to cause the device 1002 to perform various functions of the present disclosure.

The memory 1008 may include random access memory (RAM) and read-only memory (ROM). The memory 1008 may store computer-readable, computer-executable code including instructions that, when executed by the processor 1006 cause the device 1002 to perform various functions described herein. The code may be stored in a non-transitory computer-readable medium such as system memory or another type of memory. In some implementations, the code may not be directly executable by the processor 1006 but may cause a computer (e.g., when compiled and executed) to perform functions described herein. In some implementations, the memory 1008 may include, among other things, a basic I/O system (BIOS) which may control basic hardware or software operation such as the interaction with peripheral components or devices.

The I/O controller 1014 may manage input and output signals for the device 1002. The I/O controller 1014 may also manage peripherals not integrated into the device 1002. In some implementations, the I/O controller 1014 may represent a physical connection or port to an external peripheral. In some implementations, the I/O controller 1014 may utilize an operating system such as iOS®, ANDROID®, MS-DOS®, MS-WINDOWS®, OS/2®, UNIX®, LINUX®, or another known operating system. In some implementations, the I/O controller 1014 may be implemented as part of a processor, such as the processor 1006. In some implementations, a user may interact with the device 1002 via the I/O controller 1014 or via hardware components controlled by the I/O controller 1014.

In some implementations, the device 1002 may include a single antenna 1016. However, in some other implementations, the device 1002 may have more than one antenna 1016, which may be capable of concurrently transmitting or receiving multiple wireless transmissions. The receiver 1010 and the transmitter 1012 may communicate bi-directionally, via the one or more antennas 1016, wired, or wireless links as described herein. For example, the receiver 1010 and the transmitter 1012 may represent a wireless transceiver and may communicate bi-directionally with another wireless transceiver. The transceiver may also include a modem to modulate the packets, to provide the modulated packets to one or more antennas 1016 for transmission, and to demodulate packets received from the one or more antennas 1016.

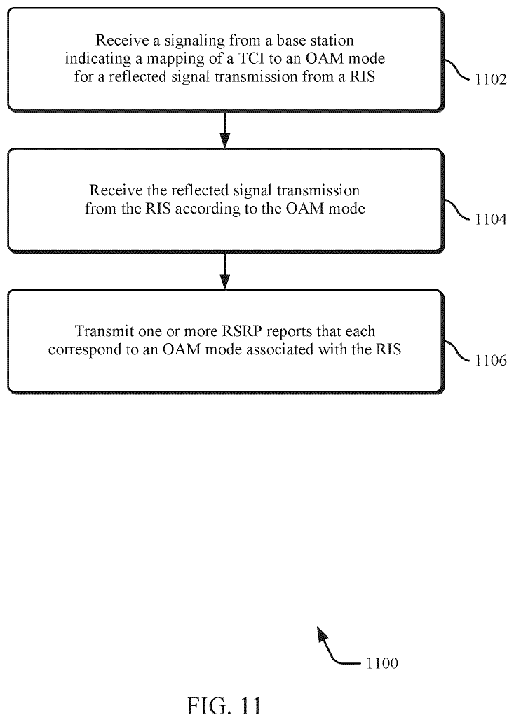

FIG. 11 illustrates a flowchart of a method 1100 that supports RIS configuration for OAM in accordance with aspects of the present disclosure. The operations of the method 1100 may be implemented and performed by a device or its components, such as a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1102, the method may include receiving a signaling from a base station indicating a mapping of a TCI to an OAM mode for a reflected signal transmission from a RIS. The operations of 1102 may be performed in accordance with examples as described herein. In some implementations, aspects of the operations of 1102 may be performed by a device as described with reference to FIG. 1.

At 1104, the method may include receiving the reflected signal transmission from the RIS according to the OAM mode. The operations of 1104 may be performed in accordance with examples as described herein. In some implementations, aspects of the operations of 1104 may be performed by a device as described with reference to FIG. 1.

At 1106, the method may include transmitting one or more RSRP reports that each correspond to an OAM mode associated with the RIS. The operations of 1106 may be performed in accordance with examples as described herein. In some implementations, aspects of the operations of 1106 may be performed by a device as described with reference to FIG. 1.

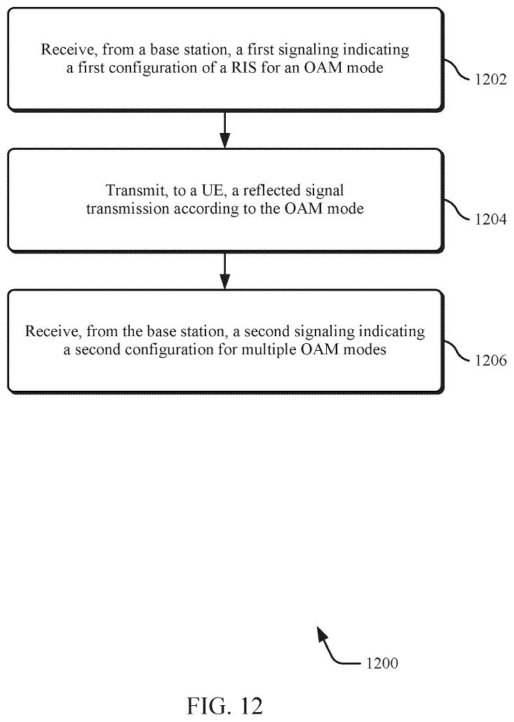

FIG. 12 illustrates a flowchart of a method 1200 that supports RIS configuration for OAM in accordance with aspects of the present disclosure. The operations of the method 1200 may be implemented and performed by a device or its components, such as a RIS 116 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1202, the method may include receiving, from a base station, a first signaling indicating a first configuration of a RIS for an OAM mode. The operations of 1202 may be performed in accordance with examples as described herein. In some implementations, aspects of the operations of 1202 may be performed by a device as described with reference to FIG. 1.

At 1204, the method may include transmit, to a UE, a reflected signal transmission according to the OAM mode. The operations of 1204 may be performed in accordance with examples as described herein. In some implementations, aspects of the operations of 1204 may be performed by a device as described with reference to FIG. 1.

At 1206, the method may include receiving, from the base station, a second signaling indicating a second configuration for multiple OAM modes. The operations of 1206 may be performed in accordance with examples as described herein. In some implementations, aspects of the operations of 1206 may be performed by a device as described with reference to FIG. 1.

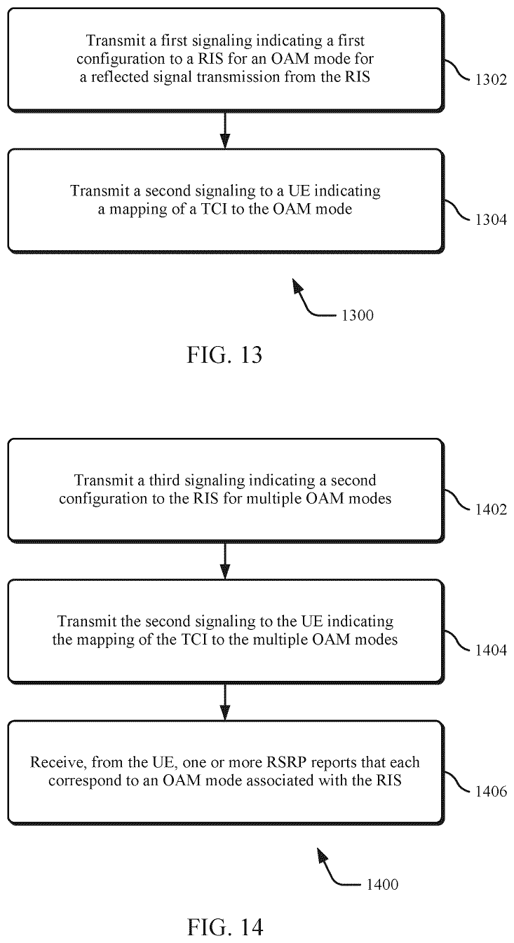

FIG. 13 illustrates a flowchart of a method 1300 that supports RIS configuration for OAM in accordance with aspects of the present disclosure. The operations of the method 1300 may be implemented and performed by a device or its components, such as a base station 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1302, the method may include transmitting a first signaling indicating a first configuration to a RIS for an OAM mode for a reflected signal transmission from the RIS. The operations of 1302 may be performed in accordance with examples as described herein. In some implementations, aspects of the operations of 1302 may be performed by a device as described with reference to FIG. 1.

At 1304, the method may include transmitting a second signaling to a UE indicating a mapping of a TCI to the OAM mode. The operations of 1304 may be performed in accordance with examples as described herein. In some implementations, aspects of the operations of 1304 may be performed by a device as described with reference to FIG. 1.

FIG. 14 illustrates a flowchart of a method 1400 that supports RIS configuration for OAM in accordance with aspects of the present disclosure. The operations of the method 1400 may be implemented and performed by a device or its components, such as a base station 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1402, the method may include transmitting a third signaling indicating a second configuration to the RIS for multiple OAM modes. The operations of 1402 may be performed in accordance with examples as described herein. In some implementations, aspects of the operations of 1402 may be performed by a device as described with reference to FIG. 1.

At 1404, the method may include transmitting the second signaling to the UE indicating the mapping of the TCI to the multiple OAM modes. The operations of 1404 may be performed in accordance with examples as described herein. In some implementations, aspects of the operations of 1404 may be performed by a device as described with reference to FIG. 1.

At 1406, the method may include receiving, from the UE, one or more RSRP reports that each correspond to an OAM mode associated with the RIS. The operations of 1406 may be performed in accordance with examples as described herein. In some implementations, aspects of the operations of 1406 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A base station for wireless communication, comprising:
at least one memory; and
at least one processor coupled with the at least one memory and configured to cause the base station to:
transmit a first signaling indicating a first configuration to a reconfigurable intelligent surface (RIS) for an orbital angular momentum (OAM) mode for a reflected signal transmission from the RIS; and
transmit a second signaling to a user equipment (UE) indicating a mapping of a transmission configuration indicator (TCI) to the OAM mode.

2. The base station of claim 1, wherein the at least one processor is configured to cause the base station to:
transmit a third signaling indicating a second configuration to the RIS for multiple OAM modes; and
transmit the second signaling to the UE indicating the mapping of the TCI to the multiple OAM modes.

3. The base station of claim 2, wherein the second configuration comprises a list of OAM mode numbers associated with the multiple OAM modes, the OAM mode numbers based at least in part on the first signaling indicating the OAM mode.

4. The base station of claim 2, wherein the second configuration comprises:
a list of OAM mode numbers associated with the multiple OAM modes to be generated by the RIS; and
configuration information to map one or more OAM modes of the multiple OAM modes to one of multiple spatial directions configured for data transmissions with multiple UEs utilizing different OAM modes of the multiple OAM modes.

5. The base station of claim 2, wherein the second signaling configures the UE to at least one of:
receive multiple data transmissions with the multiple OAM modes using different TCI states associated with respective different RISs; or
transmit multiple data transmissions with the multiple OAM modes using the different TCI states associated with the respective different RISs.

6. The base station of claim 1, wherein the first configuration comprises one or more of a phase, an amplitude, or an element state of one or more RIS elements to at least one of configure the RIS for the OAM mode of the reflected signal transmission, or alter the OAM mode of the reflected signal transmission.

7. The base station of claim 1, wherein the first configuration comprises a first mode number of the OAM mode for a signal transmission from the base station and a second mode number of the OAM mode of the reflected signal transmission by the RIS.

8. The base station of claim 1, wherein the second signaling configures the UE with one or more OAM modes for at least one of receiving or transmitting data transmissions, and the one or more OAM modes are mapped to a TCI state and each TCI state is associated with the RIS.

9. (canceled)

10. A reconfigurable intelligent surface (RIS) for wireless communication, comprising:
at least one memory; and
at least one processor coupled with the at least one memory and configured to cause the RIS to:
receive, from a base station, a first signaling indicating a first configuration of the RIS for an orbital angular momentum (OAM) mode; and
transmit, to a user equipment (UE), a reflected signal transmission according to the OAM mode.

11. The RIS of claim 10, wherein the at least one processor is configured to cause the RS to receive a second signaling indicating a second configuration for multiple OAM modes.

12. The RIS of claim 11, wherein the second configuration comprises a list of OAM mode numbers associated with the multiple OAM modes to be generated by the RIS, the OAM mode numbers generated by the RIS based at least in part on the first signaling indicating the OAM mode.

13. The RIS of claim 11, wherein the second configuration comprises:
a list of OAM mode numbers associated with the multiple OAM modes to be generated by the RIS; and
configuration information to map one or more OAM modes of the multiple OAM modes to one of multiple spatial directions configured for data transmissions with multiple UEs utilizing different OAM modes of the multiple OAM modes.

14. The RIS of claim 10, wherein the first configuration comprises one or more of a phase, an amplitude, or an element state of one or more RIS elements to at least one of configure the RIS for the OAM mode of the reflected signal transmission, or alter the OAM mode of the reflected signal transmission.

15. The RIS of claim 10, wherein the first configuration comprises a first mode number of the OAM mode for a signal transmission from the base station and a second mode number of the OAM mode of the reflected signal transmission by the RIS.

16. A user equipment (UE) for wireless communication, comprising:
at least one memory; and
at least one processor coupled with the at least one memory and configured to cause the UE to:
receive a signaling from a base station indicating a mapping of a transmission configuration indicator (TCI) to an orbital angular momentum (OAM) mode for a reflected signal transmission from a reconfigurable intelligent surface (RIS); and
receive the reflected signal transmission from the RIS according to the OAM mode.

17. The UE of claim 16, wherein the signaling from the base station indicates the mapping of the TCI to multiple OAM modes associated with a configuration of the RIS for the multiple OAM modes.

18. The UE of claim 17, wherein the signaling configures the UE to at least one of:
receive multiple data transmissions with the multiple OAM modes using different TCI states associated with respective different RISs; or
transmit multiple data transmissions with the multiple OAM modes using the different TCI states associated with the respective different RISs.

19. The UE of claim 16, wherein the signaling configures the UE with one or more OAM modes for at least one of receiving or transmitting data transmissions, and the one or more OAM modes are mapped to a TCI state and each TCI state is associated with the RIS.

20. The UE of claim 16, wherein:
the signaling configures the UE to report one or more reference signal received power (RSRP) reports that each correspond to an OAM mode associated with the RIS; and
the at least one processor is configured to cause the UE to transmit the one or more RSRP reports that each correspond to the OAM mode associated with the RIS.

21. A processor for wireless communication, comprising:
at least one controller coupled with at least one memory and configured to cause the processor to:
receive a signaling from a base station indicating a mapping of a transmission configuration indicator (TCI) to an orbital angular momentum (OAM) mode for a reflected signal transmission from a reconfigurable intelligent surface (RIS); and
receive the reflected signal transmission from the RIS according to the OAM mode.
